(19) United States
(12) Patent Application Publication
(10) Pub. No.: US 2011/0107198 A1
(43) Pub. Date: May 5, 2011

(54) INFORMATION PROCESSING APPARATUS, STORAGE MEDIUM, AND INFORMATION PROCESSING METHOD

(75) Inventor: Ken Kuroda, Kawasaki-shi (JP)

(73) Assignee: CANON KABUSHIKI KAISHA, Tokyo (JP)

(21) Appl. No.: 12/913,294

(22) Filed: Oct. 27, 2010

(30) Foreign Application Priority Data
Oct. 29, 2009 (JP) 2009-249093

(51) Int. Cl. G06F 17/00

(52) U.S. Cl. 715/234

(57) ABSTRACT

An information processing apparatus sets each folder managed in a first document management system as a registration target folder, and determines whether a depth of the registration target folder is equal to or less than a limit value of a depth of folder hierarchy. If the depth of the target folder is determined to be equal to or less than the limit value of the depth, the apparatus registers the registration target folder at a position, in a folder hierarchy managed by a second document management system, which corresponds to a position in a folder hierarchy managed by the first system. If the depth of the target folder is determined to exceed the limit value of the depth, the apparatus registers the registration target folder in a shallow layer having a depth smaller than the limit value of the depth in the folder hierarchy managed by the second system.

### BACKGROUND OF THE INVENTION

1. Field of the Invention

The present invention relates to an apparatus for migrating data from a document management system to another document management system differing in restriction of a folder structure therefrom.

2. Description of the Related Art

Most electronic document management systems manage electronic documents using a plurality of folders configured in a hierarchical structure.

Japanese Patent Application Laid-Open No. 2002-82828 discusses a system in which when a document is moved from a source folder to a destination folder by a user's operation, a document for notifying/searching a destination is generated under the source folder to have the same name as that of the moved document and attributes including destination information such that a user can search for the document moved to and stored in the destination folder using the generated document.

When a new document management system is introduced, it is necessary to migrate data thereto from a previous document management system used until then. At that time, the new document management system may differ from the previous document management system in the limit value of a depth of folder hierarchy that can be managed by the document management system due to differences in specifications between the document management systems. Sometimes, e.g., an upper limit to a length of a path name of each folder or to a maximum value of the number of layers of folder hierarchy is provided as the restriction of the depth of folder hierarchy which can be managed by the document management system. When the limit value of the depth of the folder hierarchy managed by the document management system at a data migration destination is small (e.g., the length of a path name is short, or the upper limit value of the number of layers of the folder hierarchy is small), folders stored in the previous document management system cannot be migrated while maintaining the hierarchical configuration thereof. Thus, when the path name of a folder generated in the previous document management system is long, or when the maximum number of layers of folder hierarchy is large, this situation falls under the restriction of the document management system at the data migration destination.

On the other hand, when a user's manual operation causes a document and a folder to move, as discussed in Japanese Patent Application Laid-Open No. 2002-82828, the user takes trouble. If a folder hierarchy configuration before migration is performed is drastically changed after the migration is performed, it is difficult for users to search for a target folder or document.

### SUMMARY OF THE INVENTION

According to an aspect of the present invention, an information processing apparatus for registering data concerning folders and documents managed by a first document management system, in a second document managing system, includes a depth determination unit configured to set each folder managed by the first document management system as a registration target folder and to determine whether a depth of the registration target folder is equal to or less than a limit value of a depth of folder hierarchy, a folder registration unit configured to register, if the depth determination unit determines that the depth of the registration target folder is equal to or less than the limit value of the depth, the registration target folder at a position, in the folder hierarchy managed by the second document management system, which corresponds to a position in the folder hierarchy managed by the first document management system, and to register, if the depth determination unit determines that the depth of the registration target folder exceeds the limit value of the depth, the registration target folder in a shallow layer having a depth smaller than the limit value of the depth in the folder hierarchy managed by the second document management system, and a document registration unit configured to register each document included in the registration target folder under the folder registered in the second document management system by the folder registration unit.

According to an exemplary embodiment of the present invention, data can be migrated from a source document management system to a new document management system such that the depth of the folder hierarchy is not too large in the new document management system while a folder configuration in the source document management system is maintained as much as possible in the new document management system.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a configuration of a system according to an exemplary embodiment of the present invention.

FIG. 2 is a diagram illustrating a procedure for migrating data from an old document management system to a new document management system according to an exemplary embodiment of the present invention.

FIG. 3A is a diagram illustrating a configuration of a data exporter according to an exemplary embodiment of the present invention. FIG. 3B is a diagram illustrating a configuration of a data importer according to an exemplary embodiment of the present invention.

FIG. 4 is a flowchart illustrating a registration process performed by the data importer according to an exemplary embodiment of the present invention.

FIG. 5 is a flowchart illustrating a folder division process performed when data is imported according to an exemplary embodiment of the present invention.

FIG. 6A is a schematic diagram illustrating a folder hierarchy managed by an old document management application according to an exemplary embodiment of the present invention. FIG. 6B is a schematic diagram illustrating a folder hierarchy managed by a new document management application according to an exemplary embodiment of the present invention.

FIG. 7A is a diagram illustrating an example of information described in a division source information file according to an exemplary embodiment of the present invention. FIG. 7B is a diagram illustrating an example of information described in a division destination information file according to an exemplary embodiment of the present invention.

FIG. 8 is a flowchart illustrating an export process performed by the data exporter according to an exemplary embodiment of the present invention.

### DESCRIPTION OF THE EMBODIMENTS

Various exemplary embodiments, features, and aspects of the invention will be described below with reference to the drawings.

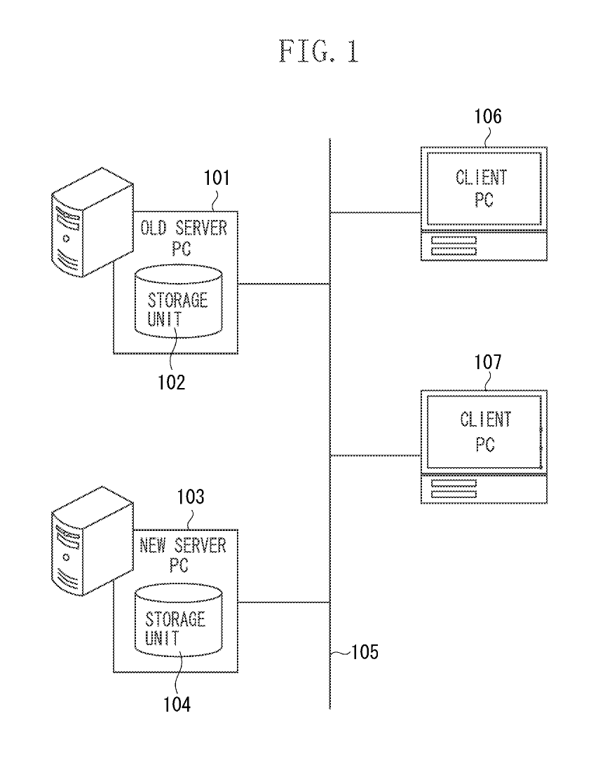

FIG. 1 is a diagram illustrating a configuration of a system according to an exemplary embodiment of the present invention. In the following description of the present exemplary embodiment, a process of migrating data having a folder hierarchical structure managed by an old electronic document management system (first document management system) is described, which is performed when the data is migrated from the old electronic document management system to a different electronic document management system (second document management system).

Each of an old server personal computer (PC) 101 and a new server PC 103 is configured by hardware components such as a central processing unit (CPU), a random access memory (RAM), a read-only memory (ROM), a hard disk drive (HDD), and a network interface card. Each PC is an information processing apparatus according to an exemplary embodiment of the present invention. On the old server PC 101, a document management server program of the old electronic document management system runs, which manages data before the data is migrated. A storage unit 102 stores folders, documents, attribute information, and the like managed by the document management system before data migration. On the new server PC 103, a server program of the new electronic document management system runs, which manages data after the data migration. Data such as folders, documents, and attribute information, which are managed by the document management system after the data migration, are migrated to a storage unit 104. The storage units 102 and 104 are regions in each of which various data of the associated document management system are saved. Each of the regions respectively serving as the storage units 102 and 104 is secured on the HDD of the associated one of the servers 101 and 103.

Client PCs 106 and 107 are connected via a network 105 to the servers 101 and 103, in each of which the associated electronic document management system operates. A user can access the document management system operating on the server PC 101 or 103, using a client application program of the document management system and a web browser, which run on the server PC 101 or 103. In addition, the user can also, e.g., browse, register, and edit documents and folders. FIG. 1 illustrates only two client PCs. However, an additional plurality of client PCs can be connected to the servers 101 and 103 via the network 105.

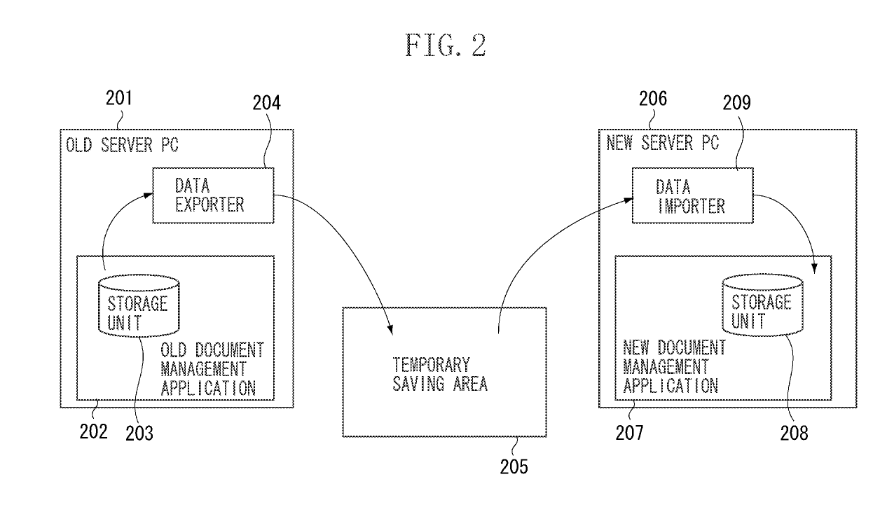

A data migration procedure performed when data, such as documents and folders managed by the previous document management system, is migrated to another document management system therefrom is described hereinafter with reference to FIG. 2.

On an old server PC 201, a server application of the electronic document management system used till then (hereinafter referred to as an old document management application) 202 runs. A storage unit 203 stores various information, such as folders and documents, managed by the old document management system. A data exporter 204 exports information managed by the old document management application 202. According to the present exemplary embodiment, a computer (CPU) of the old server PC 201 functions as the data exporter (data writing device) 204 which exports data managed by the old document management system by executing a computer program. A temporary saving area 205 is a storage area which temporarily stores data written thereto by the data exporter 204. A storage area to be utilized as the temporary saving area 205 is secured in the storage unit, such as an HDD and a memory, of the old server PC 201 according to the present exemplary embodiment. However, the temporary saving area 205 according to the present exemplary embodiment is not limited thereto and can be secured in the storage unit of a new server PC 206. Alternatively, the temporary saving area 205 can be secured in a common folder on a third PC on the network or provided on a medium, such as a universal serial bus (USB) memory, a compact disc (CD), a digital versatile disc (DVD), and/or the like. Information written to the temporary saving area 205 is encrypted by the data exporter 204. Alternatively, a right to access the information written to the temporary saving area 205 can be given to a specific user by the data exporter 204. Thus, confidentiality is preserved by preventing the information from being accessed by general users.

On the new server PC 206, another new electronic document management application (hereinafter referred to as a new document management application) 207 runs. A storage unit 208 stores various information concerning folders and documents managed by the new document management application 207. A data importer 209 registers or imports information in or to the storage unit 208 managed by the new document management application 207. According to the present exemplary embodiment, a computer (CPU) of the new server PC 206 functions as the data importer (data reading device) 209 which imports data written by the old document management system by executing a computer program.

The program of the data exporter 204, that of the data importer 209, and the server program of the document management system are stored in a computer-readable storage medium. Each CPU reads the stored program therefrom and executes the read program, if necessary. Such programs are assumed to be supplied to the system or the devices via various types of storage media or the network.

FIG. 2 illustrates an example of causing the old document management system and the new document management system to operate on the different server PCs 201 and 206, respectively. However, a mode of operating the document management systems according to the present exemplary embodiment is not limited thereto. The present invention can be applied to a case of causing the old document management system and the new document management system to function on the same apparatus as logically different document management servers. That is, although the old document management application 202 and the new document management application 207 are executed in different server apparatuses in the example illustrated in FIG. 2, both of the document management applications 202 and 207 can be caused to run on the same PC.

FIG. 2 illustrates the example in which the old document management application 202 and the storage unit 203 exist on the same PC 201. However, the old document management application 202 and the storage unit 203 can be configured to respectively operate on different PCs. That is, the storage unit 203 can be formed of a separate apparatus to be connected to the document management server (i.e., the old server PC 201) via the network or the like. Similarly, the new document management application 207 and the storage unit 208 can be configured to respectively operate on different PCs.

FIG. 2 also illustrates the example in which the data exporter 204 and the old document management application 202 exist on the same PC 201. However, the old document management application 202 and the data exporter 204 can be configured to respectively operate on different PCs. Similarly, the data exporter 209 and the new document management application 207 can be configured to respectively operate on different PCs.

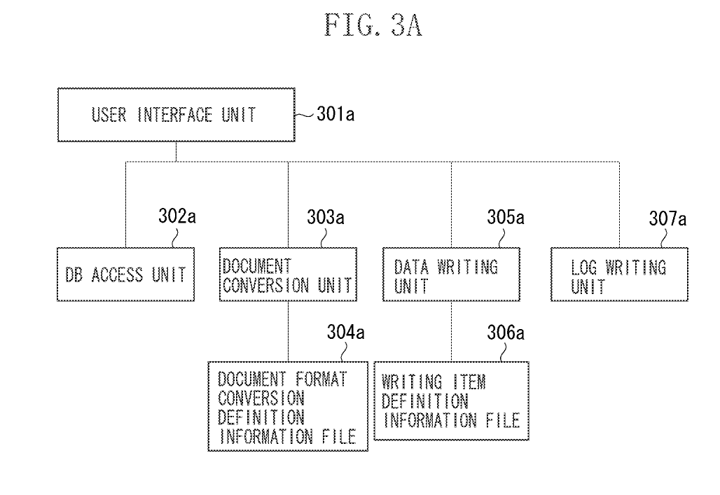

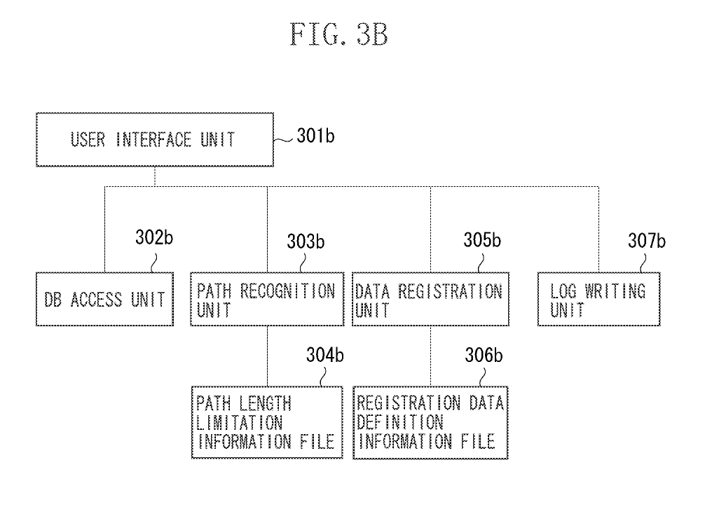

FIG. 3A is a diagram illustrating a configuration of processing units configuring the data exporter 204. The computer of the PC 201 executes a computer program to function as each processing unit configuring the data exporter illustrated in FIG. 3A. A user interface unit 301a causes a display device to display information. The user interface unit 301a also receives an instruction input from a user. A database (DB) access unit 302a accesses the storage unit 203 managed by the old document management application 202 and reads folder configuration information, document file information, various attribute information, and the like stored in the storage unit 203.

A document conversion unit 303a performs format conversion on a document file brought from a DB access unit 302a. The document conversion unit 303a reads information concerning a file format to be converted, and a post-conversion file format from a document format conversion definition information file 304a. The document format conversion definition information file 304a is an information file which is preliminarily defined and stored on an HDD or a memory. The preliminarily stored document format definition information file 304a can be edited or updated later by an administrator user or the like. In addition, a substitution definition information file can be distributed later, so that the preliminarily stored document format definition information file 304a can be replaced with the substitution definition information file. The document conversion unit 303a converts all of a plurality of image data of different formats (e.g., bitmap, jpeg, and gif formats) into data of portable document format (PDF) data. Such conversion is performed to preliminarily convert data formats handled by the old document management application 202 into those which can be handled by the new document management application 207, when the old document management application 202 and the new document management application 207 differ from each other in formats (document formats), which can be handled by the document management application. The document format conversion definition information file 304a can preliminarily be defined such that the document conversion unit 303a does not perform conversion on formats which can be handled by both of the old document management application 202 and the new document management application 207.

A data writing unit 305a writes, to the temporary saving area 205, a file (i.e., a configuration information file) of information concerning the configuration of each folder read by the DB access unit 302a, an entity file of a document read by the DB access unit 302a or of a document converted by the document conversion unit 303a, and various attribute information of each of folders and documents. The configuration information file to be written is a file generated by the data writing unit 305a and includes information concerning the configuration of the folder hierarchy managed by the old document management application, information representing a link to an entity file concerning a document stored in each folder, and information representing a link to attribute information concerning each of folders and documents. The data writing unit 305a refers to a writing item definition information file 306a and writes the file in a preliminarily defined form. The writing item definition information 306a is an information file in which items concerning documents, folders, and attributes to be written, and information concerning a format (e.g., an extensible markup language (XML) format) used when writing information representing the configuration of folders managed by the old document management application are defined. In addition, an operation of writing information concerning specifications of the old document management application (e.g., information concerning restrictions of a depth of the folder hierarchy, and the number of files which can be stored in a folder) is also defined in the writing item definition information file 306a. Although the writing item definition information file 306a is an information file preliminarily defined and registered, the writing item definition information file 306a can be edited or updated later by an administrator user or the like. In addition, a substitution definition information file can be distributed later, so that writing item definition information file 306a can be replaced with the substitution definition information file.

A log writing unit 307a records a log of an operating condition of the data exporter 204. Users refer to the log. Consequently, the users can confirm later whether data is correctly written, and can check error information.

FIG. 3B is a diagram illustrating a configuration of processing units configuring the data importer 209. The computer functions as each processing unit configuring the data importer 209 illustrated in FIG. 3B by executing a computer program. A user interface portion 301b causes a display device to display information, and receives an instruction input from a user.

A data registration unit 305b reads a configuration information file, an entity file of a document, and various attribute information written to the temporary saving area 205. Then, the data registration unit 305b registers, in the storage unit 208 managed by the new document management application 207, the folder and the file of the document and the various attribute information via a DB access unit 302b while the configuration of the folder hierarchy is corrected to that conforming to specifications of the new management application 207 by cooperating with a path recognition unit 303b. At that time, the data registration unit 305b refers to a registration data definition information file 306b and determines information to be actually registered. In the registration data definition information file 306b, rules are defined, which include, e.g., a rule that among the files of documents written by the data writing unit 305a, the files of document, which have a specific extension, are not registered, and a conversion rule that characters which cannot be used by the new document management application 207 are replaced with those which can be used by the new document management application 207. According to the specifications of the new document management application 207, the following rule can also be registered in the registration data definition information file 306b. That is, a rule can be registered where date-type attribution information is converted into a character string. The registration data definition information file 306b can be edited and updated later by an administrator user or the like according to a type of the new document management application file at the migration destination. In addition, a substitution definition information file can be distributed later, so that registration data definition information file 306b can be replaced with the substitution definition information file. For example, information representing the upper limit value of the number of subfolders which can be located under a folder by the new document management application 207 is also written to the registration data definition information file 306b. The information representing the upper limit value of the number of subfolders is utilized to check whether the number of subfolders managed by the old document management application 202 exceeds the upper limit value of the number of subfolders. Preferably, data is migrated by causing the data registration unit 305b to newly generate another folder when the number of subfolders managed by the old document management application 202 exceeds the upper limit value, and to make the newly generated folder store subfolders of the number by which the upper limit value is exceeded. The registration data definition information file 306b is needed because the old document management application 202 may differ from the new document application 207 in the specifications thereof. The data registration unit 305b performs data migration while causing data of the old document management application 202 to conform as much as possible to the data format of the new document management application 207. Thus, data loss can be reduced.

The path recognition unit 303b determines whether each folder to be migrated exceeds the restriction of the depth of the folder hierarchy managed by the new document management application 207. In the following description of the present exemplary embodiment, it is described by way of example that the path recognition unit 303b determines whether, e.g., a folder path length (i.e., the length of a path name of each folder) of a folder managed by the new document management application 207 exceeds the upper limit of the depth of the folder hierarchy. However, a criterion for the determination according to the present exemplary embodiment is not limited thereto. For example, when there is an upper limit value of the number of layers of the folder hierarchy according to the specifications of the new document management application, the number of layers of the folder hierarchy can be employed as a criterion for determining whether each folder to be migrated exceeds the restriction of the depth of the folder hierarchy. A path length limitation information file 304b stores information concerning a limit value (e.g., an upper limit value of the folder path length, and that of the number of layers of the folder hierarchy) of the depth of folder hierarchy managed by the new document management application 207. The path recognition unit 303b reads the upper limit value of the folder path length from the path length limitation information file 304b and determines whether the folder path length of each folder to be migrated exceeds the read upper limit value. Then, the path recognition unit 303b notifies the data registration unit 305b of a result of determining whether the folder path length of each folder to be migrated exceeds the upper limit value. The path length limitation information file 304b is a preliminarily defined information file and can be edited or updated later by an administrator user or the like. In addition, a substitution definition information file can be distributed later, so that the path length limitation information file 304b can be replaced with the substitution definition information file.

A DB access unit 302b accesses the storage unit 208 managed by the new document management application 207 and registers in the storage unit 208 folders, documents, and various attribute information designated by the data registration unit 305b as registration targets. A log writing unit 307b records a log of an operating condition of the data importer 209. Users refer to the log. Consequently, the users can confirm later whether data is correctly written, and can check error information.

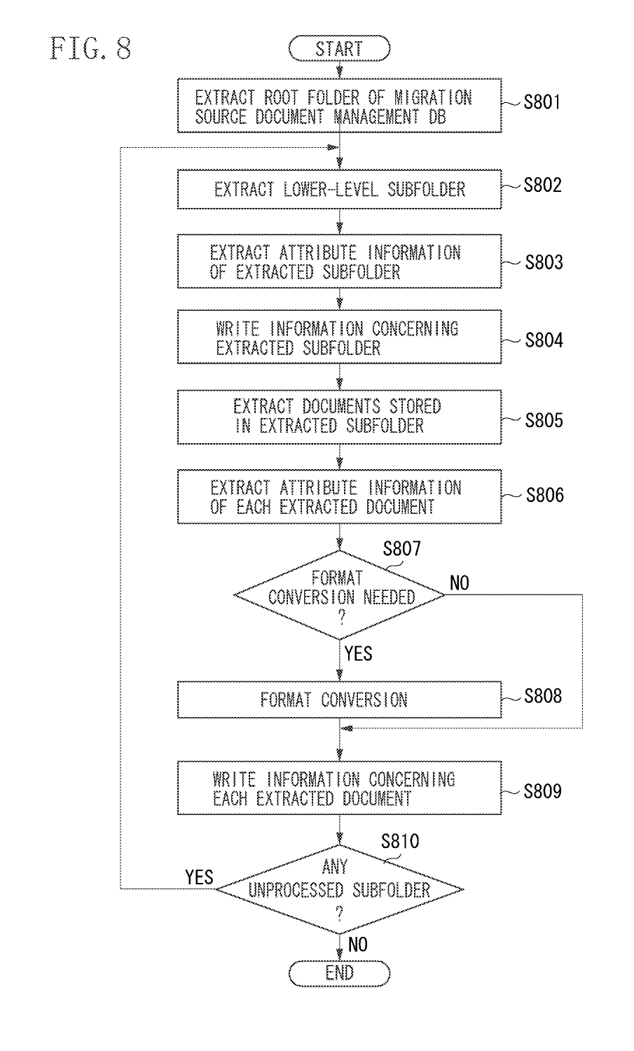

Next, a process in which the data exporter 204 writes folders, documents, and attribute information managed by the old document management application 202 is described hereinafter with reference to a flowchart illustrated in FIG. 8.

In step S801, the DB access unit 302a reads, from the storage unit 203 managed by the old document management application 202 at a migration source, a root folder of a document management database to be migrated. Then, the data writing unit 305a generates a new configuration information file and adds, to the configuration information file, information concerning the read root folder. Then, the data writing unit 305a writes the configuration information file to the temporary saving area 205. The configuration information file is a file generated in the XML format so that folder configuration information can be added thereto in a step which will be described below. At that time, the data writing unit 305a writes, to an attribute information file, attribution information (e.g., information concerning an access right) of the document management database.

In step S802, the DB access unit 302a reads subfolders existing at lower levels. First, the DB access unit 302a reads a subfolder existing immediately under the root folder. In addition, in step S803, the DB access unit 302a reads attribute information of the subfolder read in step S802.

In step S804, the data writing unit 305a adds, to the written configuration information file, information concerning a configuration-level of the read subfolder in the folder hierarchy. The data writing unit 305a writes attribute information of the read subfolder to the attribute information file.

In step S805, the DB access unit 302a reads one or more documents stored in the subfolder read in step S802. In addition, in step S806, the DB access unit 302a reads attribute information of each of the read documents.

In step S807, the document conversion unit 303a determines whether each of the documents read in step S805 needs format conversion. In step S808, the document conversion unit 303a performs format conversion on a document determined as needing format conversion. However, the document conversion unit 303a does not perform format conversion on a document determined as needing no format conversion.

In step S809, the data writing unit 305a writes an entity file of each of the read documents (i.e., each read document file or each document file subjected to format conversion) to the temporary saving area 205. In addition, the data writing unit 305a associates a configuration information file with an entity file of each document by adding to the configuration information file information concerning which of the subfolders stores the entity file of each read document. In addition, the data writing unit 305a writes to the attribute information file the attribute information of each document read in step S806, and associates the attribute information with a corresponding entity file or a corresponding part located in the configuration information file.

In step S810, the DB access unit 302a determines whether there is any unprocessed subfolder. If the DB access unit 302a determines that there is an unprocessed subfolder (YES in step S810), the process returns to step S802, in which the DB access unit 302 extracts the next subfolder. If the DB access unit 302 determines that the export of all subfolders (and documents) is completed, the process ends.

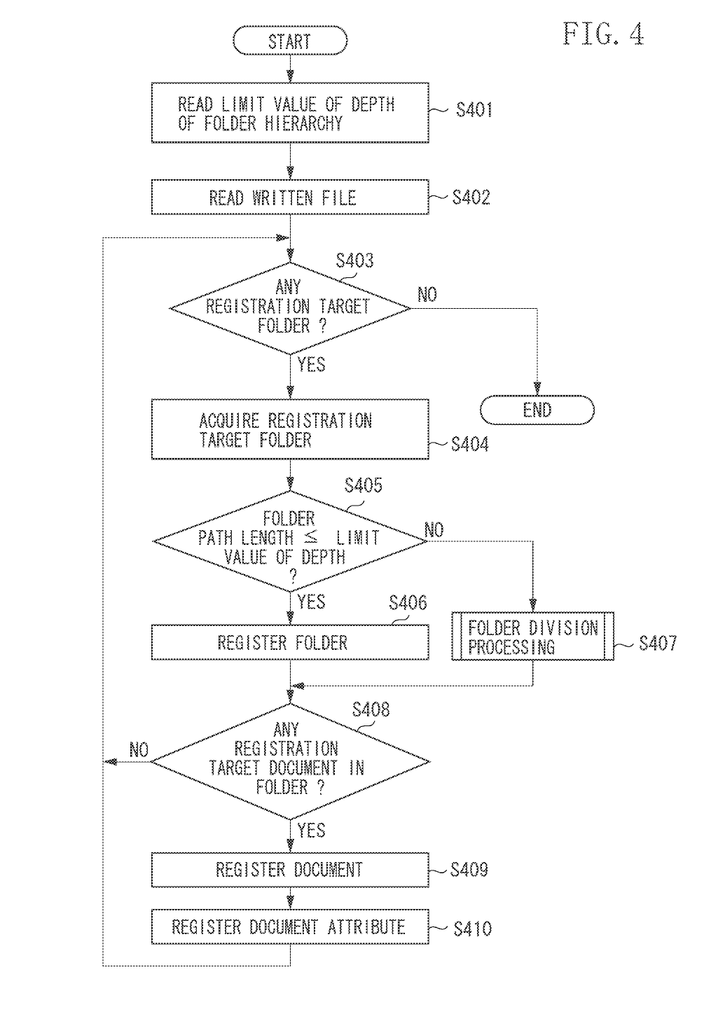

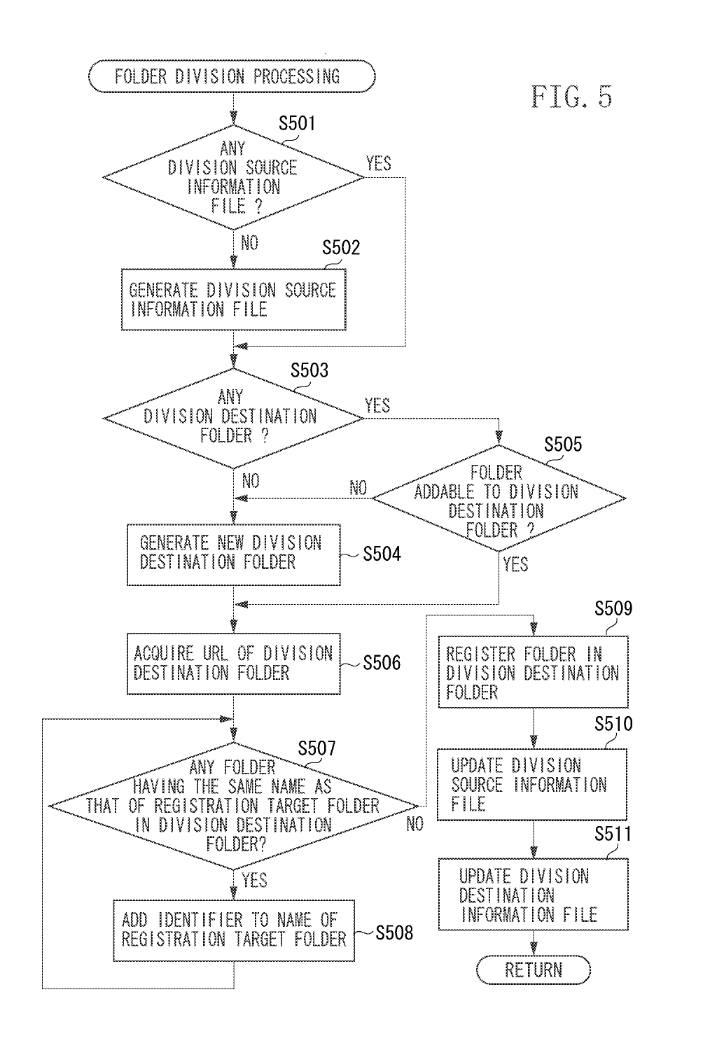

Next, a process of registering folders, documents, and attribute information in the new document management application by the data importer 209 is described with reference to flowcharts illustrated in FIGS. 4 and 5.

First, in step S401, the path recognition unit 303b reads from the path length limitation information file 304 a limit value (e.g., a limit value of a folder path length) of the depth of folder hierarchy. The read limit value is stored in a storage area. The limit value is equal to or less than, e.g., “1500 bytes” when a folder path is written in a uniform resource locator (URL). The limit value is initialized in a stage of development of the data importer 209 according to specifications of the new document management application 207. However, as described with reference to FIG. 3B, a user can reconfigure the limit value at data migration by checking the specifications of the new document management application 207.

In step S402, the data registration unit 305b reads the configuration information file written to the temporary saving area 205 by the data exporter 204 and analyzes, based on the description in the read configuration information file, the configuration of folder hierarchy managed by the old document management application 202.

In step S403, the data registration unit 305b determines, based on a result of the analysis, whether there is any folder to be registered in the storage unit 208 managed by the new document management application 207 (i.e., whether there is an unregistered folder). First, the data registration unit 305b determines whether a folder exists just under the root folder. After processing is performed in each step which will be described below, subfolders existing just under each folder sequentially become determination targets. In step S403, if the data registration unit 305b determines that there is no folder to be registered (NO in step S403), the process ends. If the data registration unit 305b determines that there is a folder to be registered (YES in step S403), the process proceeds to step S404, in which the data registration unit 305b acquires, from the attribute information, a name of the folder to be registered. Then, the data registration unit 305b generates a folder to be employed as a registration target.

In step S405, the path recognition unit 303b determines whether the folder path length of the folder serving as a registration target, which is generated in step S404, is equal to or less than the limit value of the depth. If the folder path length does not exceed the limit value (YES in step S405), the process proceeds to step S406, in which the data registration unit 305b registers the generated folder via the DB access unit 302b in the storage unit 208 managed by the new document management application 207 so that the configuration of folder hierarchy managed by the new document management application 207 is similar to that of the folder hierarchy managed by the old document management application 202. On the other hand, if the path recognition unit 303b determines in step S405 that the folder path length exceeds the limit value (NO in step S405), the process proceeds to step S407, in which the data registration unit 305b registers the registration target folder by performing folder division processing to move the registration target folder to a layer having a small depth so that the folder path of the registration target folder is shortened. The folder division processing is described below with reference to FIG. 5.

In step S408, the data registration unit 305b determines, based on the configuration information file read in step S402, whether one or more documents to be registered under the registration target folder exist. If the data registration unit 305b determines in step S408 that there is no document to be registered under the registration target folder (NO in step S408), the process returns to step S403, in which the data registration unit 305b determines whether there is any unregistered folder. If the data registration unit 305b determines in step S408 that one or more documents to be registered under the registration target folder exist (YES in step S408), then in step S409, the data registration unit 305b reads an entity file of each of such documents from the temporary saving area 205 and registers each of such documents under the folder registered in step S406 or S407. Next, in step S410, the data registration unit 305b reads attribute information of each registered document based on the configuration information file also read in step S402. Then, the data registration unit 305b registers the attribute information of each of such documents in the storage unit 208 managed by the new document management application 207. After that, the process returns to step S403, in which the data registration unit 305b determines again whether there is any unregistered folder.

Next, the folder division processing to be performed in step S407 by the data registration unit 305b is described with reference to a flowchart illustrated in FIG. 5.

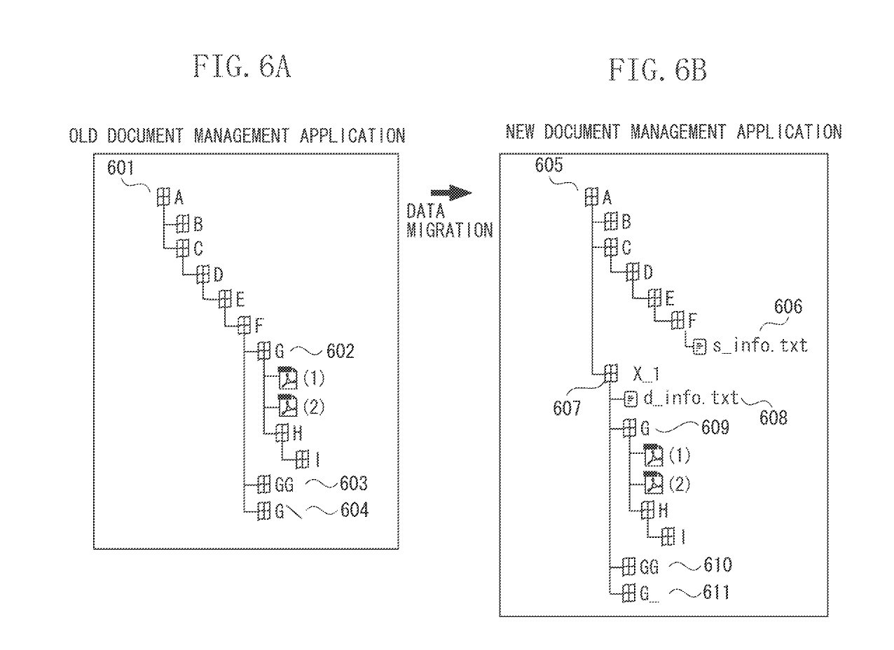

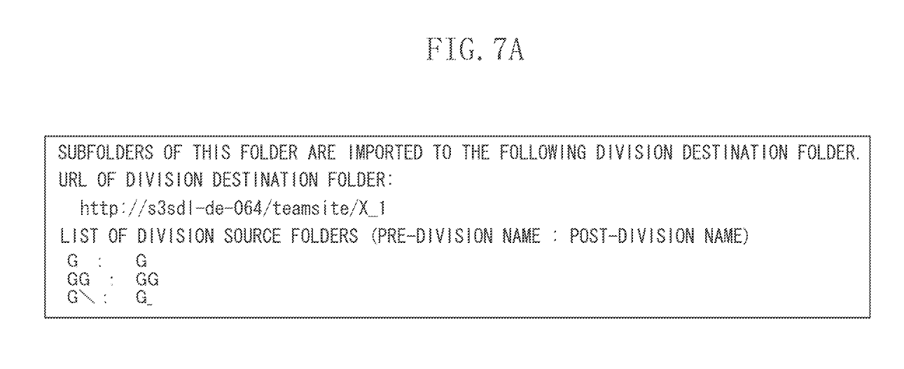

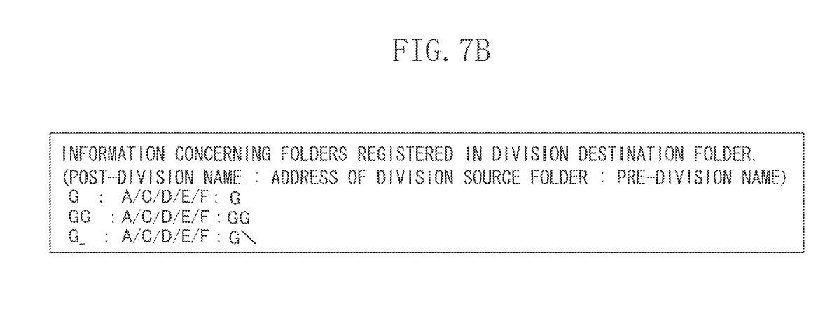

First, in step S501, the data registration unit 305b determines whether a division source information file exists (or has been generated) in a parent folder (i.e., a file whose folder path length is equal to or just less than the predetermined limit value of the depth) of the registration target folder. The division source information file is an information file stored in a parent folder serving as a division source. It is assumed that information representing a new storage destination of a divided registration target file is described in the division source information file. The division source information file is described below with reference to FIGS. 6A, 6B, and 7A. If the data registration unit 305b determines that there is no division source information file (NO in step S501), the processing proceeds to step S502, in which the data registration unit 305b generates a division source information file in the parent folder. On the other hand, if the data registration unit 305b determines in step S501 that there is a division source information file (i.e., a division source information file has been generated (YES in step S501)), the processing proceeds to step S503.

In step S503, the data registration unit 305b determines whether a division destination folder has already existed (i.e., a division destination folder has already been generated). The division destination folder is a folder newly generated in a shallow layer (i.e., an upper-level layer) of folder hierarchy managed by the new document management application 207. The division destination folder is used as a parent folder that is a new registration destination in which a registration target folder whose folder path length exceeds the limit value of the depth of folder hierarchy is registered. Each folder whose folder path length exceeds the limit value of the depth of folder hierarchy is moved to a layer whose depth is smaller than the depth of the position of a layer of folder hierarchy managed by the new document management application 207, which position corresponds to the position of the division source folder in the hierarchical structure managed by the old document management application 202. Thus, each folder whose folder path length exceeds the limit value of the depth of folder hierarchy is arranged as a subfolder of the division destination folder. The division destination folder is described below with reference to FIGS. 6A and 6B.

If the data registration unit 305b determines in step S503 that there is no division destination folder (NO in step S503), the processing proceeds to step S504, in which the data registration unit 305b generates a new division destination folder at the position of a shallow layer in the folder hierarchy managed by the new document management application 207. In addition, the data registration unit 305b preliminarily generates a division destination information file in the new division destination folder generated at that time. Information (i.e., address information of the source parent folder) concerning the folder hierarchy in which the registration target folder newly arranged in the division destination folder is originally stored is described in the division destination information file. On the other hand, if the data registration unit 305b determines in step S503 that there is a division destination folder (YES in step S503), the processing proceeds to step S505, in which the data registration unit 305b determines whether the registration target folder can additionally be located in the division destination folder. This is because the upper limit of the number of subfolders locatable under a single parent folder varies according to the specifications of the document management system. If the number of subfolders stored in the division destination folder exceeds the upper limit in step S505, the data registration unit 305b determines that no subfolder can additionally be located in the division destination folder. Thus, the processing proceeds to step S504, in which the data registration unit 305b generates a new division destination folder. The upper limit value of the number of subfolders stored in the division destination folder is defined in the registration data definition information file 306b. On the other hand, if the data registration unit 305b determines that a subfolder can additionally be located in the division destination folder (YES in step S505), the processing proceeds to step S506.

In step S506, the data registration unit 305b acquires a URL (i.e., a folder path) of the division destination folder in which the registration target folder is located, and the name of each folder located in the division destination folder. The data registration unit 305b reads the URL of the division destination folder and the name of each folder located in the division destination folder from the storage unit 208 managed by the new document management application 207 via the DB access unit 302b. Next, in step S507, the data registration unit 305b determines whether a folder having the same name as that of the registration target folder has already existed in the division destination folder. If the data registration unit 305b determines that a folder having the same name as that of the registration target folder has already existed (YES in step S507), the processing proceeds to step S508, in which the data registration unit 305b adds a random number to the end of a registration target folder name to obtain a new registration target folder name. Then, in step S507, the data registration unit 305b determines again whether a folder having the same name as the new registration target folder name of the registration target folder has already existed. That is, the data registration unit 305b changes a part of the name of the registration target folder to prevent a plurality of folders having the same name from being registered in the division destination folder.

If the data registration unit 305b determines in step S507 that a folder having the same name as that of the registration target folder does not exist (NO in step S507), the processing proceeds to step S509, in which the data registration unit 305b registers the registration target folder as a subfolder of the division destination folder via the DB access unit 302b. Next, in step S510, the data registration unit 305b updates information concerning a new storage destination of the registration target folder (i.e., information concerning an address of the division destination folder) so as to be added to the division source information file. Then, in step S511, the data registration unit 305b updates address information concerning the source parent folder of the registration target folder so as to be added to the division destination information file. The division destination file is described below with reference to FIGS. 6A, 6B and 7B.

Next, the division source information file, the division destination information file, and the division destination folder are described hereinafter with reference to examples illustrated in FIGS. 6A, 6B, 7A, and 7B.

FIG. 6A is a schematic diagram illustrating the folder hierarchy managed by the old document management application 202. Folders B and C exist as subfolders of the top root folder A (601). In addition, subfolders are located under the folder C. The data exporter 204 describes, in the configuration information file, information concerning the positions of folders and documents included in the folder hierarchy. In addition, the data exporter 204 writes the configuration information file, together with various attribute information and entity files of documents, to the temporary saving area 205.

FIG. 6B is a schematic diagram illustrating a folder hierarchy obtained as a result of a process in which the data importer 209 reads data managed by the old document management application 202 and written to the temporary saving area 205, and migrates the read data to the system managed by the new document management application 207. The folder hierarchical structure illustrated in FIG. 6B has the topmost root folder A (605). The subfolders B and C under the root folder A are located, under the root folder A, at positions similar to those of the subfolders B and C in the folder hierarchical structure managed by the old document management application 202.

It is assumed that the folder path lengths of the folders B to F do not reach the limit value of the depth of folder hierarchy. If it is determined that the folder path length of the folder G (602) exceeds the limit value of the depth of folder hierarchy when data of the folder G is migrated to the system managed by the new document management application 207, the folder G cannot be located under the folder F in the folder hierarchy managed by the new document management application 207. For example, if the server name of the new document management application 207 is “s3sd1-de-064” and each database managed by the new document management application 207 is located under a folder “teamsite”, the URL of the folder G is “http://s3sd1-de-064/teamsite/12345/a/c/d/e/f/g”. If the limit value of the depth of folder hierarchy, which is represented by the limit value of the length of the URL (i.e., folder path), is 45 bytes, the length of the URL (i.e., the folder path length) of the folder G is 46 bytes and exceeds the limit value of the depth. As described with reference to FIG. 5, when the folder path length of the folder G is determined to exceed the limit value, the data importer 209 generates a division destination folder “X_{—}1” (607) in a shallow layer. The folder G (609) is located and registered under the division destination folder 607. In the example illustrated in FIG. 6B, the folder name of the division destination folder 607 is “X_{—}1”. The number at the end of the folder name is a random number. If a folder having the same folder name as that of the division destination folder 607 has already existed, a new number is added to the end of the folder name.

A division source information file 606 is a text file. As described with reference to FIG. 5, information representing an address of the storage destination of a folder divided and moved from a position under the folder F is recorded in the division source information file 606. For example, not only the folder G (602) but the folder GG (603) and the folder G\ (604), i.e., three folders, are located under the folder F in the folder hierarchy managed by the old document management application, as illustrated in FIG. 6A. At that time, one division source information file 606 is generated under the parent folder F serving as the division source folder. Information representing the addresses of new storage destination folders corresponding to the three folders (G, GG, and G\) is recorded in the division source information file 606. Because only one division source information file exists in the division source folder, users can read through storage destination folders corresponding to a plurality of folders divided from the division source folder by browsing the division source information file.

FIG. 7A illustrates an example of information described in the division source information file 606. Because the URL (i.e., folder path) of the division destination folder is described in the division destination information file, users can know which folder a folder whose folder path length exceeds the limit value of depth is located in. In addition, the folder names of folders (i.e., divided folders) registered in the division destination folder are displayed as a list. Preferably, the folder names of the folders registered in the division destination folder are displayed by respectively associating the folder names used by the old document management application 202 with those used by the new document management application 207. This is because certain types of characters, which cannot be used by the new document management application 207, are sometimes used by the old document management application 202. For example, if the character “\” of the folder-name “G\” of the folder 604 cannot be used by the new document management application 207, the data importer 209 registers the folder 604 as a folder “G_” (611) in the division destination folder by replacing the character “\” with a character “_”, which can be used by the new document management application 207.

A division destination information file 608 is also a text file. As described with reference to FIG. 5, the address information of the parent folder serving as the division source folder is recorded such that users can identify in what position in the folder hierarchy managed by the old document management application 202 each folder registered in the division destination folder is located. In the division destination information file 608, information concerning a plurality of folders registered in the division destination folder is recorded. It is assumed that in the division destination information file 608, if a folder stored in the division source folder is registered in the division destination folder by changing the folder name, not only the address information of the parent folder serving as the division source folder but information representing the folder name which the registered folder has before the folder-name is changed is recorded. For example, if the character “\” of the folder-name “G\” of the folder 604 managed by the old document management application 202 cannot be used by the new document management application 207, the data importer 209 refers to the registration data definition information file 306b and registers the folder 604 as a folder “G_” (611) in the division destination folder by replacing the character “\” with a character “_”, which can be used by the new document management application 207. At that time, the folder name “G\” which the registered folder has before the folder-name is changed is also described in the division destination information file 608 in association with the folder name “G_”.

FIG. 7B illustrates an example of information described in the division destination information file 608. Information concerning each folder stored in the division destination folder 607 is collectively described in the division destination information file 608. Information concerning each folder, which is described in the division destination information file 608, includes the file name of each folder located in the division destination folder 607 managed by the new document management application 207, the folder path (i.e., the address of the division source folder) in the folder hierarchy previously managed by the old document management application 202, and the folder name thereof previously managed by the old document management application 202, which are described therein while being associated with one another and serially arranged on each row from the left side in this order, as illustrated in FIG. 7B. Thus, users can know, e.g., that the folder “G_” stored in the division destination folder managed by the new document management application 207 was previously stored under the division source folder F in the storage unit 203 managed by the old document management application 202, and that the original name of the folder “G_” is “G\”.

The division source information file 606 and the division destination information file 608 are not always text files. The division source information file 606 and the division destination information file 608 can be generated in either XML format or a unique format. In addition, the division source information file 606 and the division destination information file 608 are not necessarily visible from users as files. The division source information file 606 and the division destination information file 608 can be generated in a form in which the new document management application 207 can internally store the files 606 and 608 as information data, and in which the new document management application 207 can read and write the stored data.

The data exporter 204 can write data managed by the old document management application 202. However, a method for writing data according to the present exemplary embodiment is not limited thereto. For example, the apparatus according to the present exemplary embodiment can be configured so as to cause a user to select and designate a specific folder via the user interface unit 301a and as to write only lower-level folders including the selected folder. In this case, preferably, the apparatus according to the present exemplary embodiment is configured to allow a user to simultaneously select a plurality of folders and to cause the data exporter 204 to individually write lower-level folders of the designated plurality of folders to the temporary saving area 205.

The data importer 209 can register in the new document management application 207 all data written by the data exporter 204. A method for registering data in the new document management application 207 according to the present exemplary embodiment is not limited thereto. For example, the apparatus according to the present exemplary embodiment can be configured to cause a user to select and designate a specific folder from written data via the user interface unit 301a and to thereby register only the selected data in the new document management application 207. In this case, preferably, the apparatus according to the present exemplary embodiment is configured to allow a user to simultaneously select a plurality of data and to cause the data importer 209 to collectively register only a designated plurality of data. The data importer 209 according to the present exemplary embodiment is configured to allow a user to designate whether migration target data is registered at a position in the folder hierarchy managed by the new document management application 207. In this case, the data importer 209 registers the migration target data by adding a random number to the end of the folder-name of the migration target folder if a folder having the same folder name as that of the root folder of the migration target data exists at a migration target location in the folder hierarchy managed by the new document management application 207. If the topmost root folder is registered, the data importer 209 can register lower-level folders and documents regardless of the presence of a folder having the same folder name as that of a registration target folder and the presence of a document having the same name as a registration target document.

After data of a certain database is migrated to the system managed by the new document management application, sometimes, different data is additionally migrated into the same folder. Even in such a case, when one folder of data is divided into the migrated data and a new folder of data, information is added to the already generated division source information file and the already generated division destination information file. Thus, in such a case, the number of information files does not increase. If a division destination folder has already been generated, the new folder of data is located under the division destination folder. Thus, it doesn't occur that the number of division destination folders increases every time data is additionally migrated.

The above restriction on the depth of folder hierarchy, which depends on the specification of the document management system, is caused not only according to whether data can be stored therein. For example, a document management system is assumed to be configured so that when a process of searching for a document is performed, documents stored in folders deeper than a predetermined folder path, are not employed as search target documents. In this case, documents migrated to a folder deeper than searchable folders may not be searched for. Thus, when data migration is performed, the restrictions are imposed on the depth of folder hierarchy so that migration destination folders are migrated to a folder whose folder path length is equal to or less than a searchable folder path length. Consequently, all documents migrated to the folder managed by the new document management application can be set as search target documents.

Each of the above data exporter 204 and the above data importer 209 is implemented by executing the program with the computer. However, the data exporter and the data importer according to the present exemplary embodiment are not limited thereto. A part or the entirety of each of the data exporter and the data importer can be implemented by hardware (electronic circuit).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-249093 filed Oct. 29, 2009, which is hereby incorporated by reference herein in its entirety.

What is claimed is:

1. An information processing apparatus for registering data concerning folders and documents managed by a first document management system, in a second document managing system, the information processing apparatus comprising:
a depth determination unit configured to set each folder managed by the first document management system as a registration target folder and to determine whether a depth of the registration target folder is equal to or less than a limit value of a depth of folder hierarchy;
a folder registration unit configured to register, if the depth determination unit determines that the depth of the registration target folder is equal to or less than the limit value of the depth, the registration target folder at a position, in the folder hierarchy managed by the second document management system, which corresponds to a position in the folder hierarchy managed by the first document management system, and to register, if the depth determination unit determines that the depth of the registration target folder exceeds the limit value of the depth, the registration target folder in a shallow layer having a depth smaller than the limit value of the depth in the folder hierarchy managed by the second document management system; and
a document registration unit configured to register each document included in the registration target folder under the folder registered in the second document management system by the folder registration unit.

2. The information processing apparatus according to claim 1, wherein if the depth determination unit determines that the depth of the registration target folder exceeds the limit value of the depth, the folder registration unit further stores a division destination information file describing information concerning a previous parent folder of the registration target folder, in the shallow layer in which the registration target folder is registered in the second document management system.

3. The information processing apparatus according to claim 1, wherein if the depth determination unit determines that the depth of the registration target folder exceeds the limit value of the depth, the folder registration unit further stores a division source information file describing information concerning the shallow layer in which the registration target folder is registered in the second document management system, in a position corresponding to a previous parent folder of the registration target folder.

4. The information processing apparatus according to claim 1, wherein if the depth determination unit determines that the depth of the registration target folder exceeds the limit value of the depth, the folder registration unit further stores a division destination information file describing information concerning a previous parent folder of the registration target folder, in the shallow layer in which the registration target folder is registered in the second document management system, and also stores a division source information file describing information concerning the shallow layer in which the registration target folder is registered in the second document management system, in a position corresponding to the previous parent folder of the registration target folder.

5. The information processing apparatus according to claim 1, wherein the limit value of the depth is a limit value determined concerning a folder path length.

6. The information processing apparatus according to claim 1, wherein the limit value of the depth is a limit value determined concerning the number of layers of folder hierarchy.

7. The information processing apparatus according to claim 1, wherein if a name of the registration target folder includes a type of character that is unusable in the second document management system, the folder registration unit replaces the type of character with a different type of character.

8. The information processing apparatus according to claim 1, further comprising:
a data export unit configured to generate a configuration information file including information concerning a configuration of the folder hierarchy managed by the first document management system and to export the generated configuration information file,
wherein the folder registration unit sets each folder managed by the first document management system as the registration target folder by analyzing the configuration information file.

9. The information processing apparatus according to claim 8, wherein the data export unit exports the configuration information file, an entity file of a document managed by the first document management system, and attribute information of the document.

10. The information processing apparatus according to claim 9, wherein the data export unit determines whether it is necessary to perform format conversion on a document managed by the first document management system, and the data export unit performs, if the data export unit determines that it is necessary to perform format conversion thereon, format conversion on an entity file of the document.

11. The information processing apparatus according to claim 1, wherein the depth determination unit selects folders as the registration target folder in order from a folder of an upper-level layer among folders managed by the first document management system and determines whether a depth of the registration target folder is equal to or less than the limit value.

12. The information processing apparatus according to claim 11, wherein if the depth determination unit determines that the depth of the registration target folder exceeds the limit value of the depth, the folder registration unit determines whether a division destination folder has been generated in a layer whose depth is smaller than the limit value of the depth of folder hierarchy in the second document management system,
wherein if the folder registration unit determines that the division destination folder has not yet been generated, the folder registration unit generates the division destination folder,
wherein if the folder registration unit determines that the division destination folder has been generated, the folder registration unit further determines whether a folder can be added to the division destination folder, and
wherein if the folder registration unit determines that a folder cannot be added thereto, the folder registration unit generates a second division destination folder and registers the registration target folder as a subfolder of the generated division destination folder or a subfolder of the second division destination folder.

13. A computer-readable storage medium storing a computer program for registering data concerning folders and documents managed by a first document management system in a second document managing system, the computer program causing a computer to function as:
a depth determination unit configured to set each folder managed by the first document management system as a registration target folder and to determine whether a depth of the registration target folder is equal to or less than a limit value of a depth of folder hierarchy;
a folder registration unit configured to register, if the depth determination unit determines that the depth of the registration target folder is equal to or less than the limit value of the depth, the registration target folder at a position, in the folder hierarchy managed by the second document management system, which corresponds to a position in the folder hierarchy managed by the first document management system, and to register, if the depth determination unit determines that the depth of the registration target folder exceeds the limit value of the depth, the registration target folder in a shallow layer having a depth smaller than the limit value of the depth in the folder hierarchy managed by the second document management system; and
a document registration unit configured to register each document included in the registration target folder under the folder registered in the second document management system by the folder registration unit.

14. An information processing method for registering data concerning folders and documents managed by a first document management system in a second document managing system, the method comprising:
setting each folder managed by the first document management system as a registration target folder, and determining whether a depth of the registration target folder is equal to or less than a limit value of a depth of folder hierarchy;
registering, if it is determined that the depth of the registration target folder is equal to or less than the limit value of the depth, the registration target folder at a position, in the folder hierarchy managed by the second document management system, which corresponds to a position in the folder hierarchy managed by the first document management system, and registering, if it is determined that the depth of the registration target folder exceeds the limit value of the depth, the registration target folder in a shallow layer having a depth smaller than the limit value of the depth in the folder hierarchy managed by the second document management system; and
registering each document included in the registration target folder under the folder registered in the second document management system.
